(19) United States
(12) Patent Application Publication
(10) Pub. No.: US 2021/0069068 A1
(43) Pub. Date: Mar. 11, 2021

(54) TEETHING DEVICE

(71) Applicant: Tiffany S. Alima, Tucker, GA (US)

(72) Inventor: Tiffany S. Alima, Tucker, GA (US)

(21) Appl. No.: 17/019,188

(22) Filed: Sep. 11, 2020

Related U.S. Application Data
(60) Provisional application No. 62/898,650, filed on Sep. 11, 2019.

(51) Int. Cl. A61J 17/02; A61J 17/00

(52) U.S. Cl. CPC A61J 17/02; A41B 13/103; A61J 2200/00; A61J 17/111

(57) ABSTRACT

Implementations of a teething device are provided. In some implementations, the teething device comprises a teething head and a telescoping arm.

In some implementations, a method of using the teething device comprises connecting or attaching the teething device to a bib or other suitable garment, putting the teething device in an expanded configuration for usage, and inserting the teething head of the teething device into the mouth of a teething baby wearing the bib or other garment.

### CROSS REFERENCE TO RELATED APPLICATION

This application claims the benefit of U.S. Patent Application Ser. No. 62/898,650, which was filed on Sep. 11, 2019, and is incorporated herein by reference in its entirety.

### TECHNICAL FIELD

This disclosure relates to implementations of a teething device.

### BACKGROUND

Teething devices or teethers, such as teething rings, are commonly needed and used for infants/babies who are growing a first set of teeth or teething. Teething devices are handheld (i.e., not hands-free), which inconveniently or otherwise undesirably requires either a baby or a parent or other care provider to hold a teething device while it is being used by the baby.

### BRIEF DESCRIPTION OF THE DRAWINGS

FIGS. 1A-1B illustrate implementations of an example teething device according to the present disclosure.

FIGS. 2A-2F illustrate the teething device in various expanded and compacted configurations according to the present disclosure.

FIGS. 3A-3D illustrate the teething device in various expanded and compacted configurations while attached to a garment pouch according to the present disclosure.

FIG. 4 illustrates an example use of the teething device according to the present disclosure.

FIGS. 5A-5C illustrate another implementation of an example teething device according to the present disclosure.

FIGS. 6A-6E illustrate another implementation of an example teething device according to the present disclosure.

### DETAILED DESCRIPTION

Implementations of a teething device are provided. In some implementations, the teething device comprises a teething head and a telescoping arm.

In some implementations, the teething device is configured to hands-free position a teething device for a baby or child to safely and comfortably chew on for teething comfort and pain relief.

In some implementations, the teething device is configured to connect or attach to a bib or any other suitable clothing item.

In some implementations, the teething device is configured to be put into an expanded configuration wherein the teething device is at least partly extended and/or unfolded, such as for usage.

In some implementations, the teething device is configured to be put into a compacted configuration wherein the teething device is at least partly retracted and/or folded, such as for non-usage or storage.

In some implementations, the teething device may be configured to be attached to a garment within a pouch such as a pocket or other suitable enclosure of the garment.

In some implementations, the teething device may be configured to be housed or otherwise held in the pouch in a compacted configuration, such as for non-usage or storage.

In some implementations, the teething device may be configured to be placed in an expanded configuration while attached in the pouch, such as for usage of the teething device.

In some implementations, a method of using the teething device comprises connecting or attaching the teething device to a bib or other suitable garment. In some implementations, the method comprises putting the teething device in an expanded configuration for usage. In some implementations, the method comprises using the teething device by inserting the teething head of the teething device into the mouth of a teething baby or child wearing the bib or other garment.

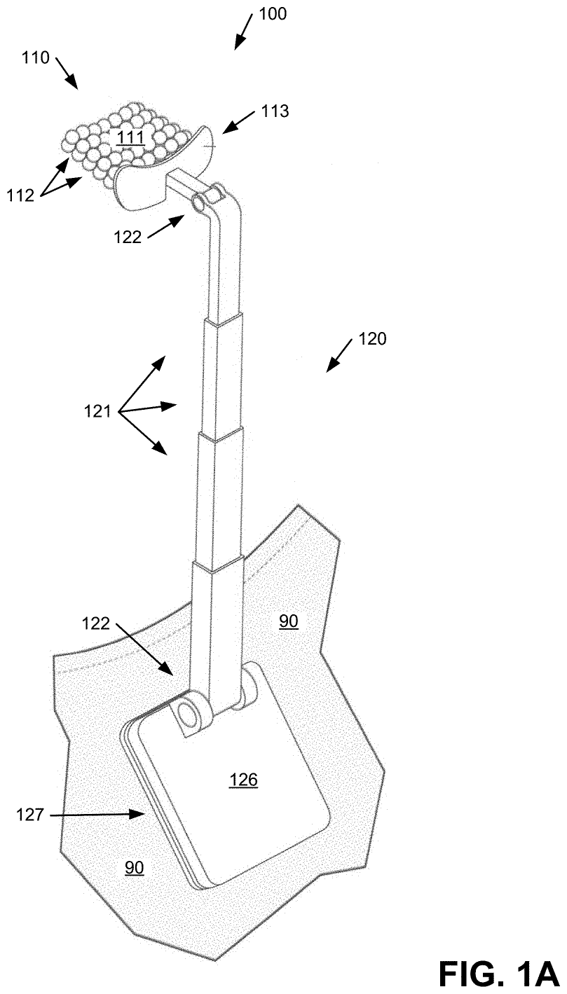

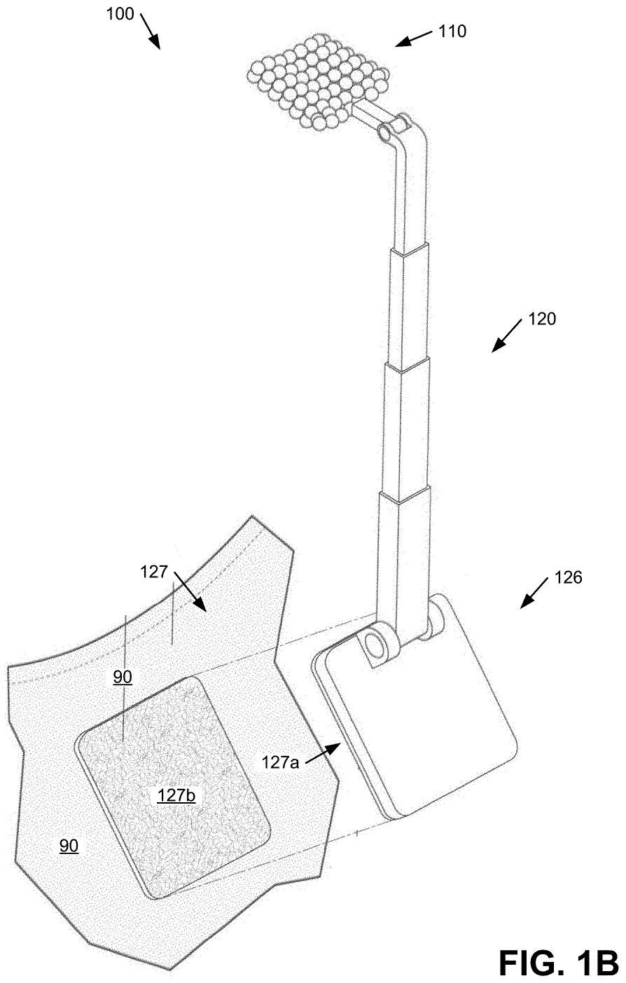

FIGS. 1A-1B illustrate implementations of an example teething device 100 according to the present disclosure. As shown in FIG. 1A, in some implementations, the teething device 100 comprises a teething head 110 and a telescoping arm 120.

As shown in FIG. 1A, in some implementations, the teething head 110 comprises a plurality of balls 111. In some implementations, the teething head 110 may further comprise a lip guard 113. In some implementations, the teething head 110 may further comprise any other suitable components.

As shown in FIG. 1A, in some implementations, the teething head 110 is generally rectangular prism shaped. In some implementations, the teething head 110 may be generally flat and/or wide, such as to allow a child to chew on the teething head 110 for teething.

In some implementations, the teething head 110 may further be shaped similar to a duck bill, such as to allow a child to chew on the teething head 110 for teething.

In some implementations, the teething head 110 may have any other suitable shape.

In some implementations, the teething head 110 is sized to be inserted into a baby's mouth for chewing. In some implementations, the teething head 110 is sized wide enough to be inserted into a baby's mouth for chewing without causing the baby to choke (e.g., choke-proof).

In some implementations, the teething head 110 may be sized small enough to fit into the mouth of a teething age infant.

In some implementations, the teething head 110 may have any other suitable sizing for such purposes (e.g., comfort, safety, etc.). In some implementations, the teething head 110 may be sized for any other suitable purpose.

In some implementations, the balls 111 are circular or spherical shaped. In some implementations, the balls 111 may be any other suitable shape.

As shown in FIG. 1A, in some implementations, the balls 111 may be arranged in a layer 112. In some implementations, the teething head 110 may comprise one or more layers 112 of the balls 111, such as the two layers 112 shown in FIG. 1A.

In some implementations, each layer 112 comprises balls 111 adjacently attached or connected together in a planar configuration. In some implementations, each layer 112 comprises balls 111 arranged (e.g., aligned) in a plurality of coplanar rows and columns. In some implementations, each layer 112 may comprise balls 111 connected together and/or arranged in any other suitable configuration.

As shown in FIG. 1A, in some implementations, the teething head 110 is attached or connected to the telescoping arm 120. In some implementations, the teething head 110 is foldably or rotateably connected to the telescoping arm 120. For example, in some implementations, the teething head 110 may be connected to the telescoping arm 120 by a hinge or other suitable component 122 that provides the rotateable connection therebetween.

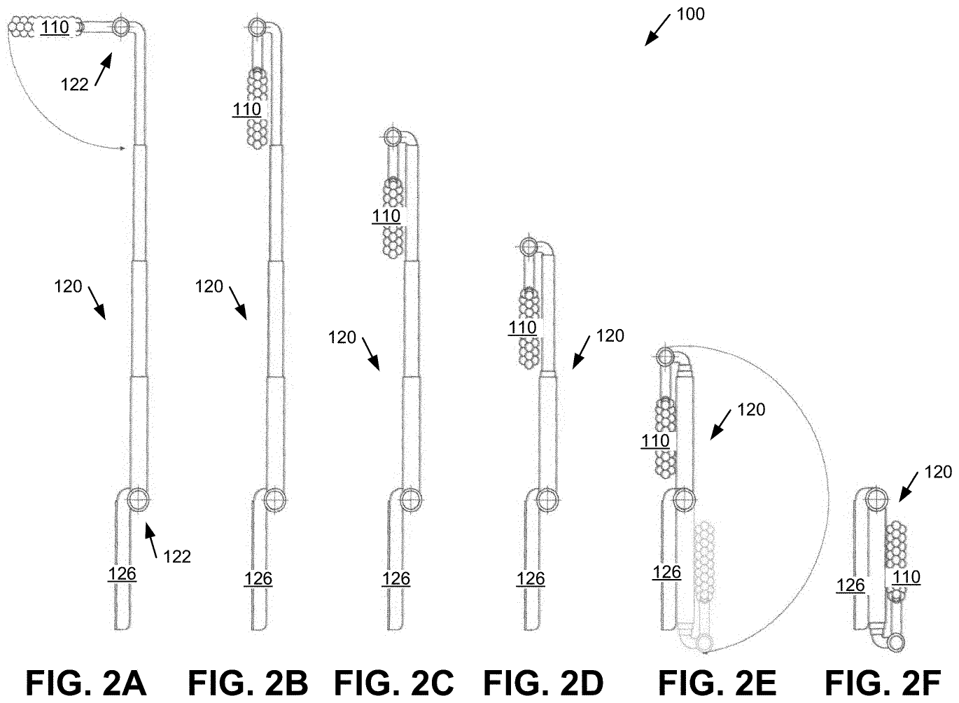

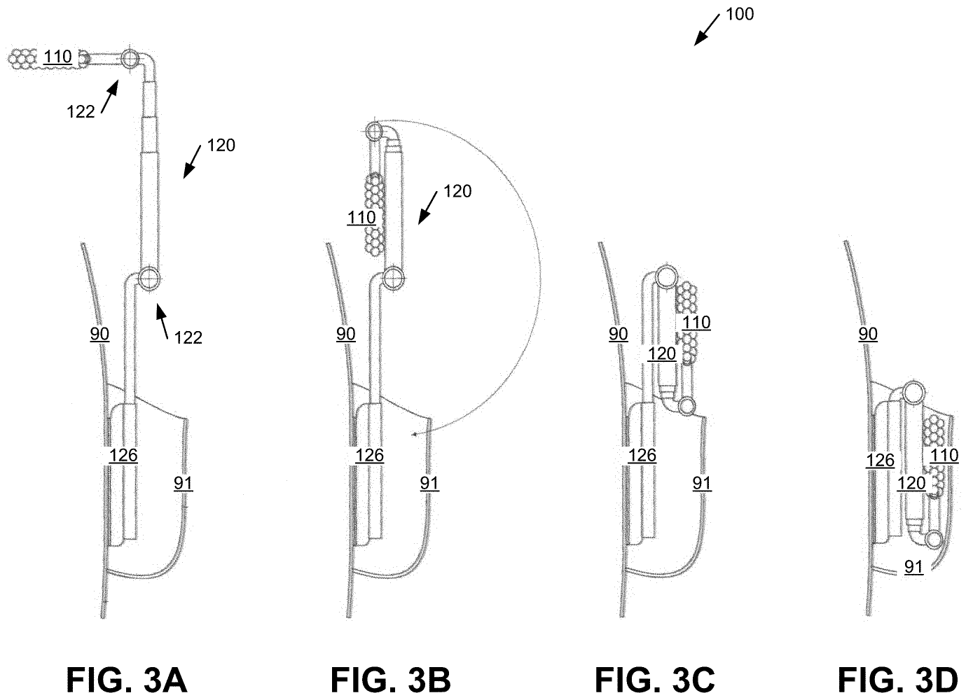

As shown in FIGS. 2A-2B and 3A-3B, in some implementations, the teething head 110 is rotateably connected to the telescoping arm 120 such that the teething head 110 can be folded or rotated away from the telescoping arm 120 and toward the telescoping arm 120. For example, as shown in FIGS. 2A and 3A, in some implementations, the teething head 110 can be rotated away from the telescoping arm 120 by the rotateable connection, such as for usage of the teething device 100. Similarly, as shown in FIGS. 2B and 3B, in some implementations, the teething head 110 can be rotated toward the telescoping arm 120 by the rotateable connection, such as for non-usage or storage of the teething device 100.

As shown in FIG. 1A, in some implementations, the teething head 110 may further comprise a lip guard 113. As shown in FIG. 1B, in some implementations, the teething head 110 may not comprise a lip guard.

In some implementations, the lip guard 113 is configured to further allow a baby or child to safely and comfortably chew on the teething head 110. For example, in some implementations, the lip guard 113 is configured to protect the baby's lips from contact with components other than the teething head 110.

In some implementations, the lip guard 113 may be configured to prevent a choking hazard by preventing the teething head 110 from inserting too far in a baby's mouth. In some implementations, the lip guard 113 may be configured to provide any other suitable features.

In some implementations, the teething head 110 is configured for comfortable chewing for a teething baby or child. For example, in some implementations, the balls 111 are configured to make the teething head 110 comfortable for chewing by a teething baby.

In some implementations, the teething head 110 may be composed of any suitable material for comfortable chewing for a teething baby.

In some implementations, the teething head 110 may comprise any other suitable features and/or configurations to provide comfortable chewing for a teething baby.

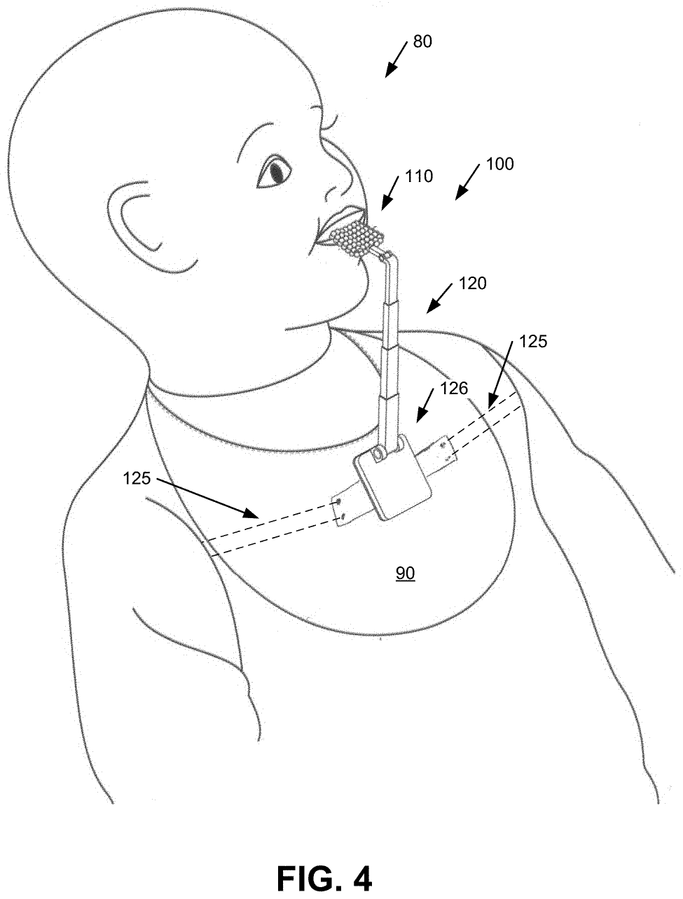

As shown in FIG. 1A, in some implementations, the telescoping arm 120 comprises one or more extensions 121 and a base 126. As shown in FIG. 4, in some implementations, the telescoping arm 120 may further comprise a support strap 125.

As shown in FIG. 1A, in some implementations, the extensions 121 each comprise an elongated member. In some implementations, the extensions 121 may each comprise any other suitable component.

In some implementations, the extensions 121 are rectangular tube shaped or rectangular bar shaped. In some implementations, the extensions 121 may comprise any other suitable shape.

In some implementations, the extensions 121 are shaped such that the extensions 121 can be telescopably or telescopingly extended apart and retracted together. In some implementations, the extensions 121 are shaped such that the extensions 121 can be extended apart and retracted together in any other suitable manner.

In some implementations, the extensions 121 are attached or connected together. In some implementations, the extensions 121 are moveably connected together. In some implementations, the extensions 121 are connected together such that the extensions 121 can be telescopingly extended apart and retracted together. In some implementations, the extensions 121 are connected together such that the extensions 121 can be extended apart and retracted together in any other suitable manner.

In some implementations, the extensions 121 are connected to and extend between the base 126 and the teething head 110. In some implementations, the extensions 121 are so connected and extend such that extending apart the extensions 121 increases the length between the base 126 and the teething head 110. In some implementations, the extensions 121 are so connected and extend such that retracting together the extensions 121 decreases the length between the base 126 and the teething head 110.

As described above with respect to the teething head 110, in some implementations, the extensions 121 are foldably or rotateably connected (e.g., at or adjacent to the top end) to the teething head 110. As described below, in some implementations, the extensions 121 are also rotateably connected (e.g., at or adjacent to the bottom end) to the base 126.

As shown in FIG. 1A, in some implementations, the base 126 comprises a generally flat, rectangular shaped (e.g., including square shaped) structure that supports the attachment of the teething device 100 to a garment 90 worn by a baby (such as a bib), as described below. For example, in some implementations, the base 126 may comprise a rectangular panel or plate. In some implementations, the base 126 may comprise any other suitably shaped component that provides the features of the base 126.

As shown in FIG. 1A, in some implementations, the base 126 is also attached or connected to the telescoping arm 120. In some implementations, the base 126 is foldably or rotateably connected to the telescoping arm 120. For example, in some implementations, the base 126 may be connected to the telescoping arm 120 by a hinge or other suitable component 122 that provides the rotateable connection therebetween.

As shown in FIGS. 2E-2F and 3C-3D, in some implementations, the base 126 is rotateably connected to the telescoping arm 120 such that the base 126 can be folded or rotated away from the telescoping arm 120 and toward the telescoping arm 120. For example, as shown in FIGS. 2E and 3C, in some implementations, the base 126 can be rotated away from the telescoping arm 120 by the rotateable connection, such as for usage of the teething device 100. Similarly, as shown in FIGS. 2F and 3D, in some implementations, the base 126 can be rotated toward the telescoping arm 120 by the rotateable connection, such as for non-usage or storage of the teething device 100.

As shown in FIG. 1B, in some implementations, the base 126 may comprise a fastener or attachment mechanism 127. In some implementations, the attachment mechanism 127 may comprise any suitable component(s) that can attach or otherwise secure the base 126 to a garment 90 worn by a baby (such as a bib), as described below. In some implementations, the attachment mechanism 127 can thereby attach the teething device 100 for use, such as described below.

For example, as shown in FIG. 1B, in some implementations, the attachment mechanism 127 may comprise a barb pad 127a and a loop pad 127b (e.g., a hook and loop mechanism, such as Velcro®).

As shown in FIG. 4, in some implementations, the support strap 125 may extend from the telescoping arm 120 to secure around a portion of a baby's body 80 to further safely and comfortably secure (e.g., reinforce) the teething device 100 to the baby while the teething device 100 is used. For example, in some implementations, the support strap 125 may extend from the base 126 to secure around the upper torso of a baby 80. In some implementations, the support strap 125 may be configured to extend from and support the teething device 100 in any other suitable way.

As shown in FIG. 4, in some implementations, the telescoping arm 120 is configured to be attached to a garment 90, such as a baby bib, on one end and to support and position the teething head 110 from the other end so that a teething baby 80 can safely and comfortably chew on the teething head 110 for teething comfort and relief.

As shown in FIGS. 2B-2E and 3A-3B, in some implementations, the telescoping arm 120 can be expanded and retracted for adjusting the length of the teething device 100 for use and storage. For example, in some implementations, the telescoping arm 120 is configured to telescopably or telescopingly expand apart and retract together, such as by the extensions 121 described above. In some implementations, the telescoping arm 120 may be configured to expand apart and retract together in any other suitable manner.

FIG. 4 illustrates an example use of the teething device 100 according to the present disclosure. As shown in FIG. 4, in some implementations, the teething device 100 is configured to hands-free position a teething device (i.e., the teething head 110) for a baby 80 to safely and comfortably chew on for teething comfort and pain relief.

In some implementations, the teething device 100 is configured to connect or attach to a bib 90 or any other suitable clothing item 90.

As shown in FIG. 1B, in some implementations, the teething device 100 is configured to removably attach to a bib 90. In some implementations, the teething device 100 may be integral with (e.g., non-removably attached to) a bib 90.

FIGS. 2A-2F illustrate the teething device 100 in various expanded and compacted configurations according to the present disclosure.

As shown in FIGS. 2A-2D, in some implementations, the teething device 100 is configured to be put into an expanded configuration wherein the teething device 100 is at least partly extended and/or unfolded, such as for usage. For example, in some implementations, when the teething head 110 is to be inserted into a baby's mouth to chew on, the telescoping arm 120 can be extended and the teething head 110 can be unfolded (i.e., rotated away) from the telescoping arm 120. In some implementations, the base 126 can also be unfolded from the telescoping arm 120 (or vice versa), such as to connect or attach the teething device 100 to a bib 90 or other suitable garment. In this way, in some implementations, the teething device 100 can be put into an expanded configuration.

As shown in FIGS. 2E-2F, in some implementations, the teething device 100 is configured to be put into a compacted configuration wherein the teething device 100 is at least partly retracted and/or folded, such as for non-usage or storage. For example, in some implementations, when the teething head 110 is to be put away (e.g., stored) or otherwise not used, the teething head 110 can be folded (i.e., rotated) toward the telescoping arm 120 and the telescoping arm 120 can be retracted. In some implementations, the base 126 can also be folded toward the telescoping arm 120 (or vice versa), such as after the teething device 100 is detached from the bib 90 or other suitable garment. In this way, in some implementations, the teething device 100 can be put into a compact configuration.

FIGS. 3A-3D illustrate the teething device 100 in various expanded and compacted configurations while attached to a garment pouch 91 according to the present disclosure.

As shown in FIGS. 3A-3D, in some implementations, the teething device 100 may be configured to connect or attach to any garment 90 having a pouch 91. In some implementations, the pouch 91 may be a pocket or other suitable garment 90 enclosure.

As shown in FIGS. 3C-3D, in some implementations, the teething device 100 in a compacted configuration, such as described above, can be housed or otherwise held in the pouch 91, such as for non-usage or storage.

As shown in FIGS. 3A-3B, in some implementations, the telescoping arm 120 can be extended to remove the teething head 110 from the pouch 91 and the teething head 110 can be unfolded from the telescoping arm 120 thereby putting the teething device 100 in an expanded configuration, such as described above, for usage of the teething device 100 by inserting the teething head 110 into a baby's mouth.

In some implementations, the teething device 100 comprises any suitable dimensions. For example, in some implementations, the teething head 110 may be 2 inches in length and 1.8 inches in width.

In some implementations, the teething head 110 may be less than or greater than 2 inches in length. In some implementations, the teething head 110 may be less than or greater than 1.8 inches in width.

In some implementations, the teething device 100 is composed of any suitable materials. For example, in some implementations, the teething device 100 is composed of a lightweight material such as a lightweight plastic material. In some implementations, the teething device 100 may be composed of any other suitable plastic or similar material.

In some implementations, the teething device 100 may be composed a silicone overmold (e.g., a silicone outer surface) with embedded massage beads (e.g., small circular surface projections), such as for massaging a teething child's gums when using the teething device 100.

In some implementations, the teething device 100 can have any suitable appearance, such as the example appearance shown in the figures.

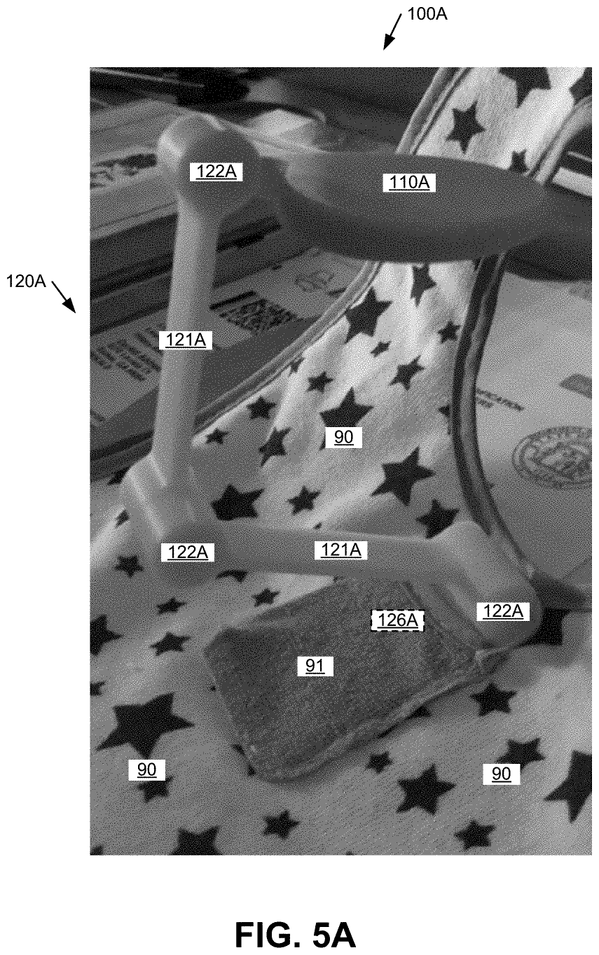

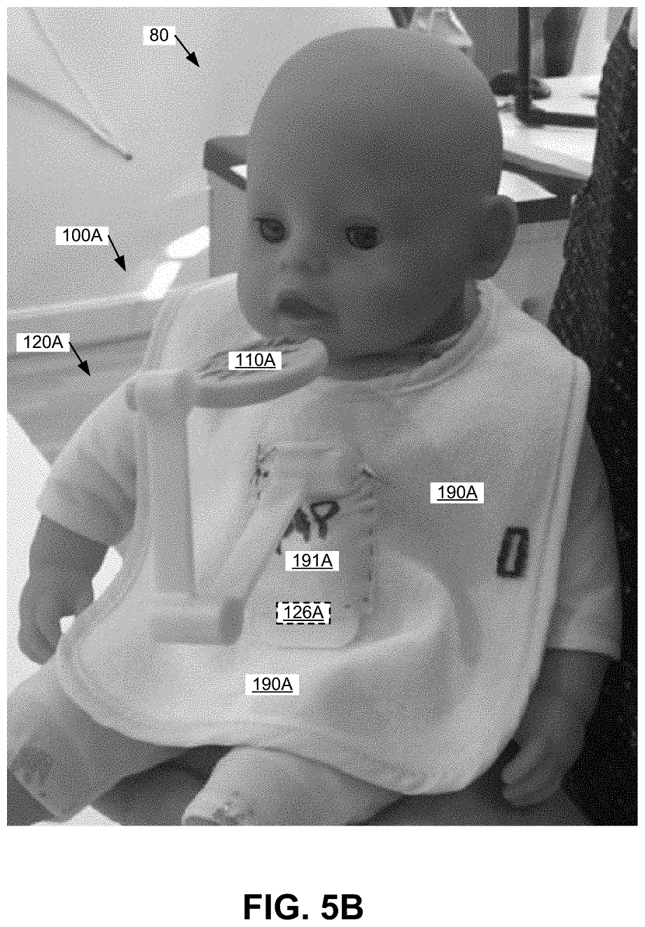

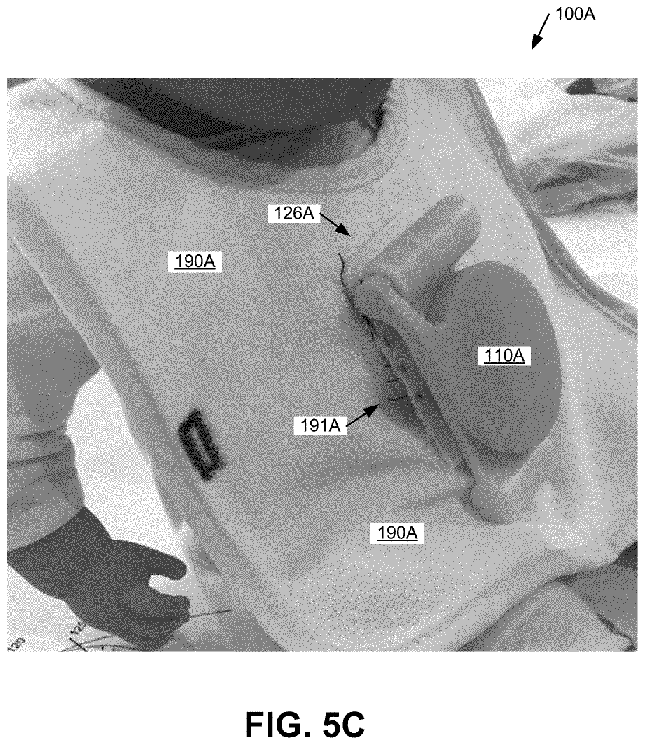

FIGS. 5A-5C illustrate another implementation of an example teething device 100A according to the present disclosure. In some implementations, the teething device 100A is generally the same or similar to the teething device 100 described herein for FIGS. 1A-1B, 2A-2F, 3A-3D, and 4, except as described below.

For example, as shown in FIG. 5A, in some implementations, the teething device 100A comprises a teething head 110A and an extending arm 120A that are generally the same or similar respectively to the teething head 110 and the telescoping arm 120 of the teething device 100. In some implementations, the extending arm 120A comprises one or more extensions 121A and a base 126A that are generally the same or similar respectively to the one or more extensions 121 and the base 126 of the telescoping arm 120.

Furthermore, as shown in FIG. 5B, in some implementations, the teething device 100A is configured to hands-free position a teething device for a baby or similar child to safely and comfortably chew on for teething comfort and pain relief generally the same or similar to the teething device 100.

As shown in FIG. 5A, in some implementations, instead of being telescopingly connected like the extensions 121, the extensions 121A are foldably or rotateably connected, for example generally the same or similar as the rotateable connection of the extension arm 120 to the teething head 110 and/or the base 126 as described for FIG. 1A. That is, in some implementations, the extensions 121A are rotateably connected by a hinge, joint, or other suitable component 122A that provides a rotateable connection therebetween.

Thereby, as shown in FIGS. 5A-5C, in some implementations, the extending arm 120A is extendable and retractable by folding or rotating the extensions 121A apart and together respectively by a rotateable connection 122A. Furthermore, as shown in FIG. 5A, in some implementations, the extending arm 120A may be foldably or rotateably connected to the teething head 110A and/or to the base 126A by a rotateable connection 122A generally the same or similar as the telescoping arm 120 of the teething device 100.

As shown in FIGS. 5A-5C, in some implementations, instead of being generally rectangular prism shaped like the teething head 110, the teething head 110A is generally oval or elliptic cylinder shaped (e.g., having a curved perimeter side extending between oval or elliptic shaped top and bottom sides). However, similar to the teething head 110, the teething head 110A may be generally flat and/or wide, such as to allow a child to chew on the teething head 110A for teething.

Furthermore, in some implementations, the teething head 110 may further be shaped similar to a duck bill, such as to allow a child to chew on the teething head 110A for teething. In some implementations, the teething head 110A may have any other suitable shape.

As shown in FIG. 5B, in some implementations, the teething device 100A may further comprise a garment such as a bib 190A that is worn by a baby or other user while using the teething device 100A. In some implementations, the bib 190A may be generally the same or similar to any other suitable bib or similar garment, such as the bib or garment 90 described herein. However, in some implementations, the bib 190A may further comprise features (such as the pocket 191A) and/or be configured (such as described herein for the bib 190A and/or described herein for the bib or garment 90) in accordance with the teething device 100, 100A described herein.

As shown in FIG. 5B, in some implementations, the garment such as the bib 190A may comprise a pouch or pocket 191A. In some implementations, the pocket 191A may be generally the same or similar to any other suitable pouch or pocket, such as the pouch or pocket 91 described herein. However, in some implementations, the pocket 191A may further comprise features and/or be configured (such as described herein for the pocket 191A and/or described herein for the pouch or pocket 91) in accordance with the teething device 100, 100A described herein.

For example, in some implementations, the pocket 191A may be configured, such as sized, shaped, positioned, etc., to receive the base 126A or other suitable part of the teething device 100A. In some implementations, the base 126A or other suitable part of the teething device 100A may also or alternately be configured to (e.g., at least partly) position, attach, etc. in the pocket 191A, such as described herein for the base 126A, 126.

In some implementations, the pocket 191A may be configured to snuggly or otherwise securely hold the base 126A (or other suitable part of the teething device 100A) in the pocket 191A. In some implementations, the base 126A (or other suitable part of the teething device 100A) may also or alternately be configured to snuggly or otherwise securely position, attach, etc. in the pocket 191A, such as described herein for the base 126A, 126.

For example, in some implementations, the pocket 191A and/or the base 126A may be configured as described above such that the teething device 100A, such as the extending arm 120A, teething head 110A, base 126A, etc.) may be extended and retracted to use the teething device 100A, 100 as described herein. In some implementations, the pocket 191A and/or the base 126A may be configured as described above such that the teething device 100A, 100 can be used or otherwise implemented as described herein.

As shown in FIG. 5C, in some implementations, the teething device 100A can be positioned and/or stored in the pouch or pocket 191A of the garment or bib 190A. For example, in some implementations, the teething device 100A may be positioned and/or stored in a retracted and/or compact(ed) configuration, such as described herein for the teething device 100, by retracting components of the teething device 100A such as the extending arm 120A, the teething head 110A, the base 126A, etc.

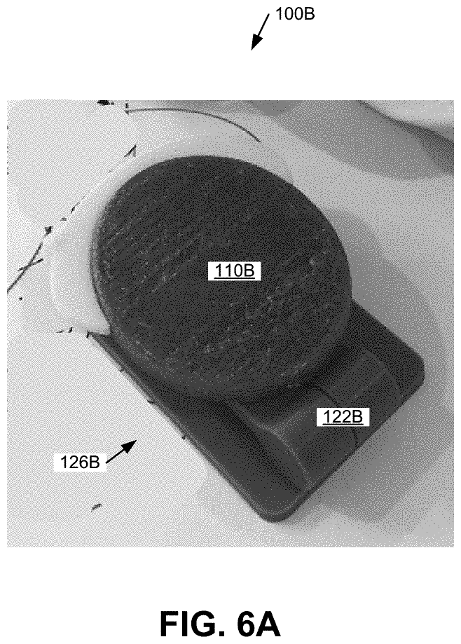

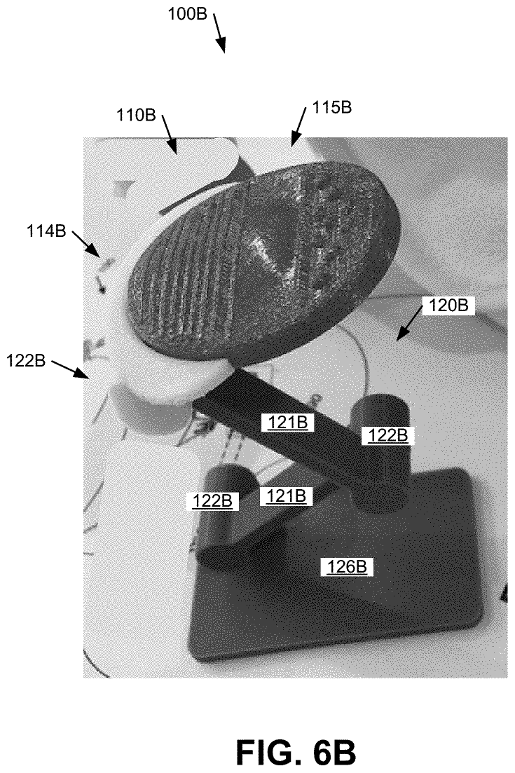

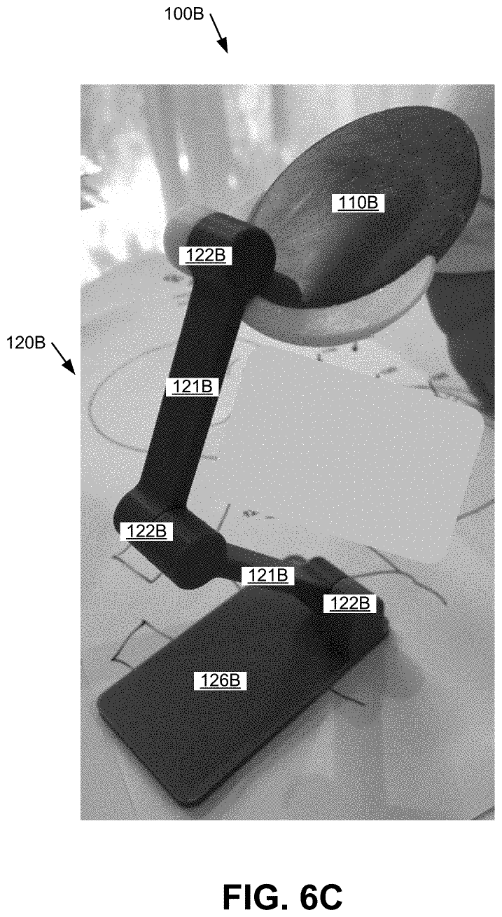

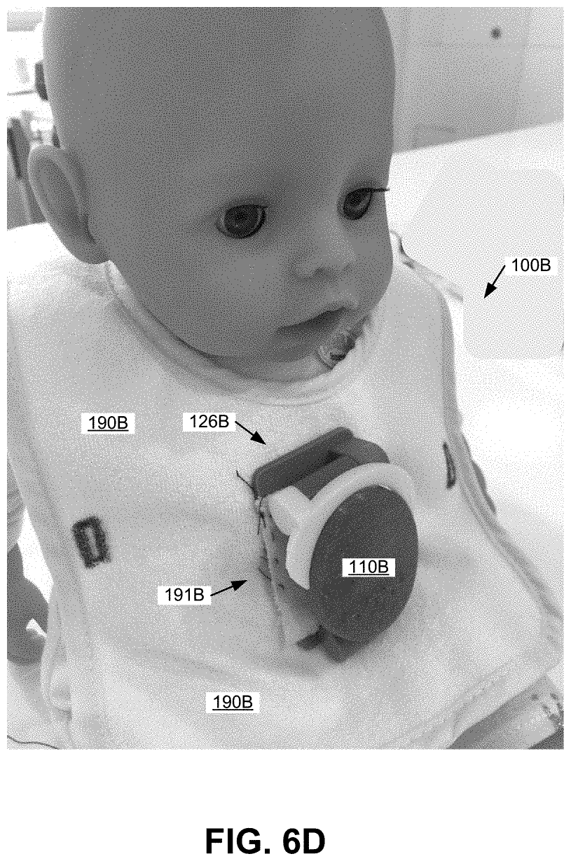

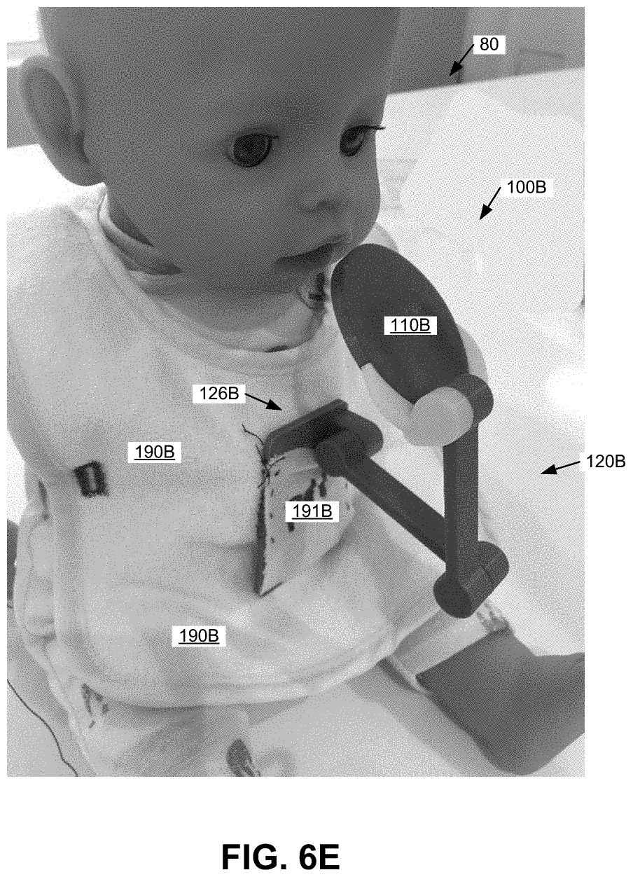

FIGS. 6A-6E illustrate another implementation of an example teething device 100B according to the present disclosure. In some implementations, the teething device 100B is generally the same or similar to the teething device 100A described herein for FIGS. 5A-5C.

For example, as shown in FIGS. 6B and 6C, in some implementations, the teething device 100B comprises a teething head 110B and an extending arm 120B that are generally the same or similar respectively to the teething head 110A and the extending arm 120A of the teething device 100A. In some implementations, the extending arm 120B comprises one or more extensions 121B and a base 126B that are generally the same or similar respectively to the one or more extensions 121A and the base 126A of the extending arm 120A.

As shown in FIGS. 6D and 6E, in some implementations, the teething device 100B may further comprise a garment such as a bib 190B that is generally the same or similar to the garment 191A of the teething device 100A.

Furthermore, as shown in FIG. 6E, in some implementations, the teething device 100B is configured to hands-free position a teething device for a baby or similar child to safely and comfortably chew on for teething comfort and pain relief generally the same or similar to the teething device 100A.

As shown in FIG. 6B, in some implementations, the teething head 110B, which is generally the same or similar to the teething head 110A, may further comprise an attachment portion 114B and a teether portion 115B that together form the teething head 110B.

FIG. 6A shows the teething device 100B in a retracted and/or compact(ed) configuration such as described herein for the teething device 100,100A. FIG. 6D shows the teething device 100B in a retracted and/or compact(ed) configuration positioned and/or stored in the pouch or pocket 191B of the garment or bib 190B such as described herein for the teething device 100,100A.

In some implementations, an example method of using the teething device 100, with respect to the above-described figures (including as shown in FIGS. 4 and 6), comprises connecting or attaching the teething device 100 to a bib 90 or other suitable garment. In some implementations, the bib 90 is being worn by a baby or similar child 80.

In some implementations, the teething device 100 may already be integrally attached to (e.g., non-removable from) the garment 90. In some implementations, the base 126 may be unfolded from the telescoping arm 120 to connect or attach the teething device 100 to the garment 90. In some implementations, the teething device 100 may be attached within a pouch 91 of the garment 90.

In some implementations, the method comprises putting the attached teething device 100 in an expanded configuration for usage of the teething device 100. In some implementations, the telescoping arm 120 is extended. In some implementations, the teething head 110 is unfolded from the telescoping arm 120.

In some implementations, the method comprises using the teething device 100 by inserting the teething head 110 into the mouth of a teething baby 80 wearing the garment 90.

In some implementations, the method further comprises putting the attached teething device 100 in a compacted configuration for non-usage or storage of the teething device 100. In some implementations, the teething head 110 is folded toward the telescoping arm 120. In some implementations, the telescoping arm 120 is retracted.

In some implementations, the method further comprises storing the teething device 100 in the pouch 91 or detaching the teething device 100 from the garment 90 for storage.

It will be understood by one skilled in the art in accordance with the present disclosure that although the teething device 100 is described herein with respect to a baby or similar child, in some implementations, the teething device 100 may be applicable to any other suitable user, such as a child, adult, person, etc.

The figures, including photographs and drawings, comprised herewith may represent one or more implementations of the teething device.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A teething device comprising:
an elongated arm that extends between a first end and a second end, wherein the arm is configured to extend and retract such that the distance between the first end and the second end increases and decreases respectively;
a teething head rotateably attached to the first end of the arm, wherein a portion of the teething head is sized to be inserted into a child's mouth and is composed of a material suitable for the child to chew on for teething comfort; and
a base rotateably attached to the second end of the arm, wherein the base is configured to securely attach to a garment such that the arm can extend from the garment and the teething head can be positioned at least partly in the child's mouth when the child is wearing the garment and using the teething device.

2. The teething device of claim 1 wherein:
the arm comprises at least a first elongated part and a second elongated part rotateably attached together and extending between the first end and the second end of the arm; and
the arm is configured to extend by rotating the first elongated part away from the second elongated part and to retract by rotating the first elongated part toward the second elongated part such that the distance between the first end and the second end of the arm increases and decreases respectively.

3. The teething device of claim 1 wherein:
the arm comprises at least a first elongated part and a second elongated part telescopably attached together and extending between the first end and the second end of the arm; and
the arm is configured to extend by telescoping the first elongated part away from the second elongated part and to retract by telescoping the first elongated part toward the second elongated part such that the distance between the first end and the second end of the arm increases and decreases respectively.

4. The teething device of claim 1 further comprising a garment, wherein the garment is configured to securely attach to the base to attach the teething device to the garment.

5. The teething device of claim 4 wherein the garment is a bib.

6. The teething device of claim 1 further comprising a garment comprising a pocket, wherein:
the pocket is configured to receive and securely hold at least a portion of the base in the pocket to attach the teething device to the garment; and
the base is configured to securely position at least partly in the pocket to attach to the garment such that the arm can extend from the pocket and the teething head can be positioned at least partly in a child's mouth when the child is wearing the garment and using the teething device.

7. The teething device of claim 6 wherein the garment is a bib.

8. The teething device of claim 1 wherein the teething head comprises a flat and wide piece of material having a silicone outer surface.

9. The teething device of claim 8 wherein the teething head further comprises a plurality of small circular surface projections configured to massage a child's gums when the child is chewing on the teething head.

10. A method of using the teething device of claim 1 comprising:
attaching the base to a garment worn by a child;
extending the arm from the base attached to the garment such that the teething head is positioned adjacent to the child's mouth; and
inserting the teething head into the child's mouth.

11. The method of claim 10 further comprising:
removing the teething head from the child's mouth; and
retracting the arm such that the teething head is moved away from the child's mouth.

12. The method of claim 11 further comprising detaching the base from the garment.

13. A method of using the teething device of claim 1 comprising placing the teething device in a compacted configuration by:
retracting the arm;
rotating the teething head toward the arm; and
rotating the base toward the arm.

14. A method of using the teething device of claim 2 comprising:
attaching the base to a garment worn by a child;
extending the arm from the base attached to the garment such that the teething head is positioned adjacent to the child's mouth; and
inserting the teething head into the child's mouth.

15. A method of using the teething device of claim 3 comprising:
attaching the base to a garment worn by a child;
extending the arm from the base attached to the garment such that the teething head is positioned adjacent to the child's mouth; and
inserting the teething head into the child's mouth.

16. A method of using the teething device of claim 4 comprising:
putting the garment on a child;
attaching the base to the garment;
extending the arm from the base attached to the garment such that the teething head is positioned adjacent to the child's mouth; and
inserting the teething head into the child's mouth.

17. The method of claim 16, wherein the garment is a bib.

18. A method of using the teething device of claim 6 comprising:
putting the garment on a child;
attaching the base to the garment by positioning the base at least partly in the pocket of the garment;
extending the arm from the base attached to the garment such that the teething head is positioned adjacent to the child's mouth; and
inserting the teething head into the child's mouth.

19. The method of claim 18, wherein the garment is a bib.

20. The method of claim 18 further comprising storing the teething device in a compacted configuration in the pocket of the garment by:
retracting the arm;
rotating the teething head toward the arm; and
rotating the arm toward the base such that the teething device is at least partly stored in the pocket of the garment in the compacted configuration.
